(19) United States
(12) Patent Application Publication
(10) Pub. No.: US 2009/0173106 A1
(43) Pub. Date: Jul. 9, 2009

(54) GLASS TEMPERING METHOD AND APPARATUS

(76) Inventor: Robert J. Boisselle, Maumee, OH (US)

Correspondence Address: MARSHALL & MELHORN, LLC;Attention: Donald A. Schurr, Four SeaGate-8th Floor, Toledo, OH, 43604, US

(21) Appl. No.: 12/348,067

(22) Filed: Jan. 2, 2009

Related U.S. Application Data
(60) Provisional application No. 61/009,974, filed on Jan. 4, 2008.

(51) Int. Cl. C03B 27/04

(52) U.S. Cl. 65/115; 65/348

(57) ABSTRACT

A glass tempering apparatus is capable of selectively delivering increased volumes of tempering medium to designated areas of a moving glass sheet to create desired stresses in such designated areas by the specific arrangement of nozzles in the glass tempering apparatus. A method of tempering glass utilizing the subject apparatus is also provided.

### RELATED APPLICATION

This application is claiming the benefit, under 35 U.S.C. 119(e), of the provisional application filed Jan. 4, 2008 under 35 U.S.C. 111 (b), which was granted Ser. No. 61/009,974. This provisional application is hereby incorporated by reference.

### BACKGROUND OF THE INVENTION

The present invention relates to an apparatus for tempering glass sheets and a method of tempering utilizing that apparatus.

Many methods of treating glass to cause it to break in small, harmless pieces, rather than large, elongated shards which can cause serious injury have been practiced. The goal of early tempering methods to treat relatively small sheets of glass was to uniformly distribute the airflow over the entirety of the surface of the glass sheet. As single glass sheets used, for example, in vehicles became larger, and the analysis of stresses in glass became more sophisticated, methods of differentially treating areas of a glass sheet were devised. One particularly intractable problem has been the elimination of inadequately tempered areas, relatively near the center of large sheets of glass such as automotive backlights.

Thus, those skilled in the art of glass tempering have continued to search for a way to improve tempering, on a consistent basis, during time-critical automotive glass manufacturing operations.

As noted, glass tempering or heat treatment is the subject of many patents, for example:

U.S. Pat. No. 5,094,678 describes a high-convection gas jet nozzle section for sheet-like material guided over rollers, in particular, for the thermal tempering of thin, flat glass sheets comprising a lower nozzle field having nozzle ribs which are arranged centrally and parallel to each other, and an upper nozzle field having nozzle ribs arranged symmetrically to the vertical axis of the lower nozzle ribs such that some gas jets are said to perpendicularly contact the sheet-like material, while others obliquely impinge on the surface of the sheet-like material, wherein the nozzle bottoms of the upper nozzle ribs are said to form a slightly modified cross-section of a letter “M”.

U.S. Pat. No. 4,662,926 describes a method of toughening glass by heating, then rapidly cooling or quenching the glass, the essential feature of the invention purportedly being that, in the quenching step, the cooling medium is caused to impinge on each side of the glass sheet in such a pattern that the glass sheet is said to be more highly toughened in a generally, circular central region and in a plurality of regions, which are substantially concentric about the center of the glass sheet and radially spaced from one another.

U.S. Pat. No. 4,402,723 describes an arrangement of quench nozzles in different densities transverse to a path of travel for glass sheets moving through a passthrough quench to facilitate removal of spent tempering medium to both lateral sides of the path of travel.

U.S. Pat. No. 4,323,385 describes an arrangement of nozzles extending from one, or a pair of opposing plenum chambers of a glass sheet tempering apparatus which arrangement is said to minimize the tendency of a large glass sheet interposed between the plenum chambers to slow the escape of tempering medium that is applied to the central portion of the glass sheet undergoing tempering.

U.S. Pat. No. 3,294,519 describes a nozzle box construction intended to create a slight pressure gradient in the tempering fluid from the center of the glass sheet outward and purportedly providing uniform tempering for large glass sheets, by increasing the width of the intermediate nozzles in their central portion to increase the percentage of aperture portion facing the central area of the glass sheet compared to other portions of same.

### SUMMARY OF THE INVENTION

The present invention relates to a glass tempering apparatus capable of selectively delivering increased volumes of a tempering medium to designated areas of a moving glass sheet to create desired stresses in such designated areas, by the specific arrangement of quench nozzles in the glass tempering apparatus. In particular, nozzles arranged in closely adjacent rows parallel to the direction of travel of the glass sheet, spanning a specified distance on either side of the centerline of the glass tempering apparatus, have been found to substantially reduce the incidence of inadequate tempering of, in particular, large sheets of glass.

A method of tempering utilizing the apparatus of the present invention is also provided.

### BRIEF DESCRIPTION OF THE DRAWINGS

FIG. 1 is a plan view of a glass tempering line in accordance with the invention.

FIG. 2 is a plan view of a representative glass sheet showing areas prone to insufficient tempering.

FIG. 3 is a perspective view of a conventional blasthead assembly.

FIG. 4 is a perspective view of a blasthead assembly with high density modules in accordance with the invention.

FIG. 5 is a cross-sectional view of first and second complementary tempering assemblies in accordance with the invention.

FIG. 6 is a graph/chart of quench air delivered to glass across the width of the blasthead assembly in accordance with a preferred embodiment of the invention.

FIG. 7 is a graph/chart comparing the occurrence of splines in a glass sheet utilizing the tempering technology of the present invention is conventional tempering apparatus.

### DETAILED DESCRIPTION OF THE INVENTION

The present invention relates to a glass tempering apparatus 10 and to a method of tempering glass sheets utilizing such apparatus. More specifically, the invention relates to an apparatus 10 for and method of selectively delivering increased volumes of tempering medium to one or more areas of at least one major surface of a glass sheet 12. The glass sheet 12 is, for example, a vehicle window. In particular, the apparatus 10 of the present invention allows for significant improvement in tempering of large glass sheets 10, such as vehicle backlights, by directing increased volumes of tempering medium toward specified areas of the glass sheet 10 where glass quality testing has shown that tempering may have been insufficient. To remedy this situation, applicants utilized the well known principle that tempering is creating stresses in the amorphous glass structure, and that areas where compressive stresses predominate make the glass stronger than in areas where tensile stresses predominate. While not wishing to be bound by any theory, applicants believe that the apparatus of the present invention reduces the undesirable occurrence of splines by as much as 90%, due to the creation of a larger number of areas of desirable stresses, but stresses of a lesser magnitude than has been typical using conventional glass tempering equipment.

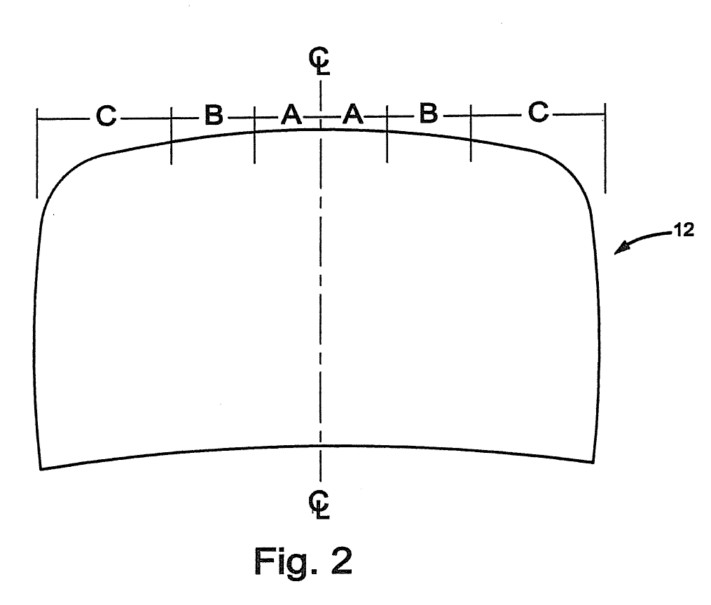

As shown in FIG. 2, in large glass sheets 12, the area found to be most prone to insufficient tempering resulting in deviations from acceptable tempering break patterns, i.e., break patterns of elongated glass shards known as “splines”, rather than small, rounded particles, occurs a relatively consistent distance (distance “A”) transversely from, and on either side of the centerline of the glass tempering apparatus. The width of the area in which the splines typically occur is also relatively consistent, and is sometimes referred to herein as distance “B”. The distance from the outer edge of distance “B” to the outermost edge of the glass sheet, transversely from its centerline is sometimes referred to herein as distance “C”. Tempering apparatus such as the present invention are sometimes referred to as “blastheads”, “quench modules” or “quench boxes.”

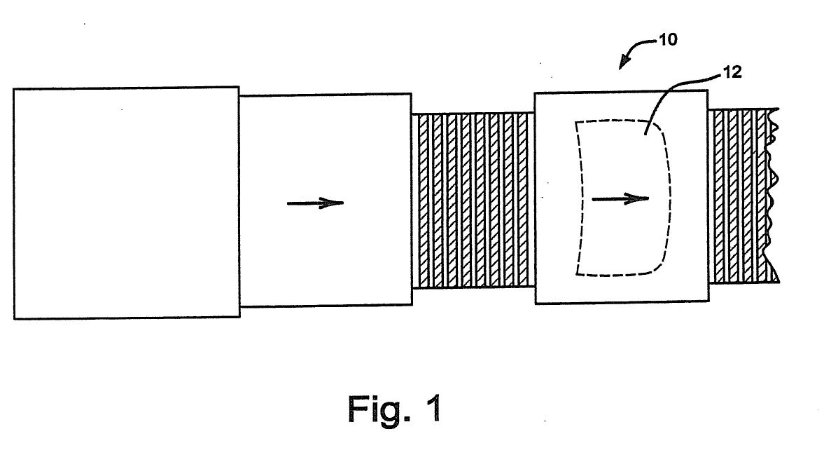

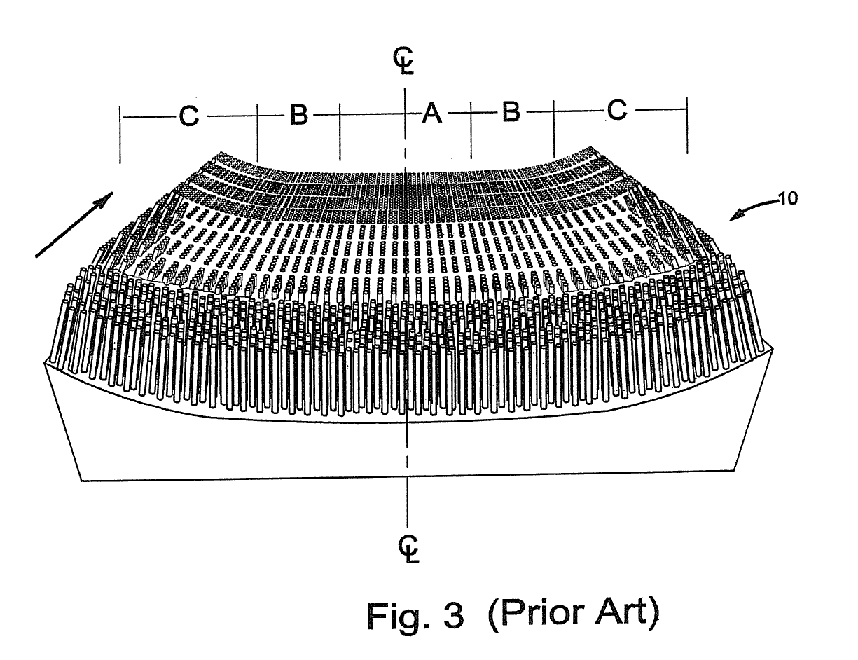

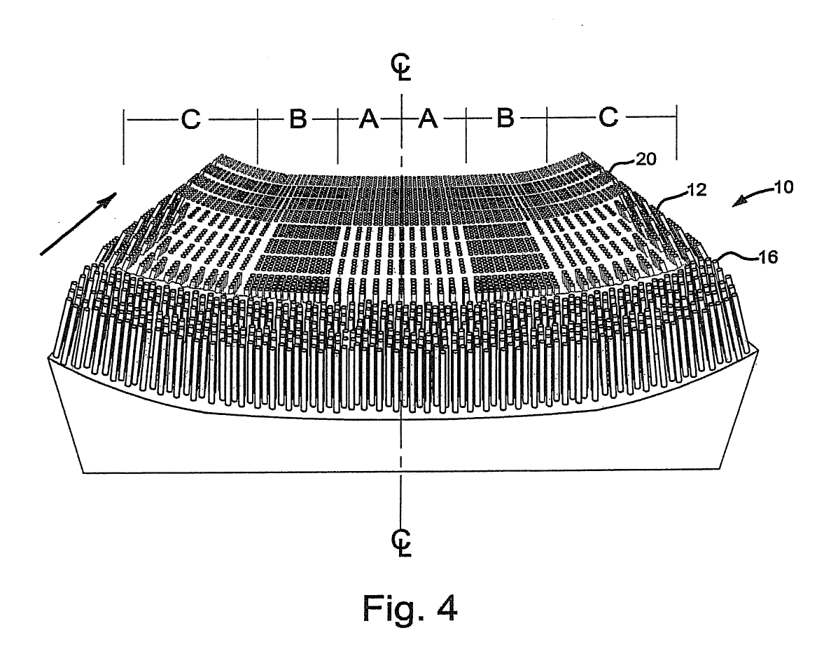

It is an advantage of the present invention that the tempering apparatus 10 can be used as a component of a typical glass tempering line 14, shown schematically in FIG. 1. A conventional blasthead assembly is shown in FIG. 3. A tempering apparatus 10 in accordance with the present invention is shown in FIG. 4.

Still with reference to FIG. 4, and in the direction denoted therein as the direction of glass travel, there is illustrated a plurality of nozzles from which tempering medium, preferably air, is emitted and directed toward a major surface of the glass sheet.

In the direction of travel of the glass sheet 12, in accordance with the invention, the glass sheet 12 first encounters a first zone having a first plurality of nozzles 16, preferably arranged in staggered rows, sometimes known as a “domino five” pattern, although other nozzle patterns are within the scope of the invention. The length of the nozzles in the first, second and third pluralities of nozzles 16, 18, 20 are predetermined to substantially conform to the shape of the glass sheet 12 to be tempered. The moving glass sheet 12 then encounters a second zone having a second plurality of nozzles 18 arranged in parallel rows, sometimes known as a “striper” or a modified striper. As can be seen, the density of the nozzles varies in an area on either side transversely of the centerline of the apparatus. Distances “A”, “B” and “C” as designated on the glass sheet 12 of FIG. 2 are superimposed on the corresponding area of the tempering apparatus 10, according to the embodiment of the present invention illustrated in FIG. 4. Finally, in its route of travel for tempering, the glass sheet 12 encounters a third zone having third plurality of nozzles 20 in a domino five, or modified domino five pattern.

Still referring to FIG. 4, in the modified striper portion 18 of the tempering apparatus 10, and in a direction transverse to the direction of glass travel, the modified striper, according to the present invention, can be described as parallel rows of nozzles from which cooling air at a temperature of from 50° F. to 150° F. is emitted toward the glass sheet 10.

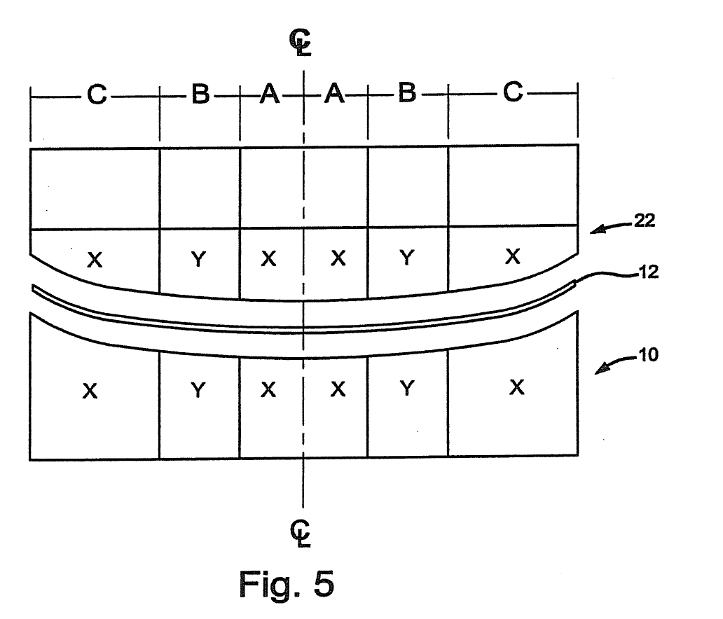

As shown, for example, in FIG. 5, the density of the nozzles in the parallel rows transverse distance “A” on either side of the centerline of the glass tempering apparatus can be designated as x, preferably on the order of 816 nozzles per square meter (m²). These nozzles are typically about 6-9 mm in diameter. The density of the nozzles distance “A” from the centerline is typical of conventional striper quench modules.

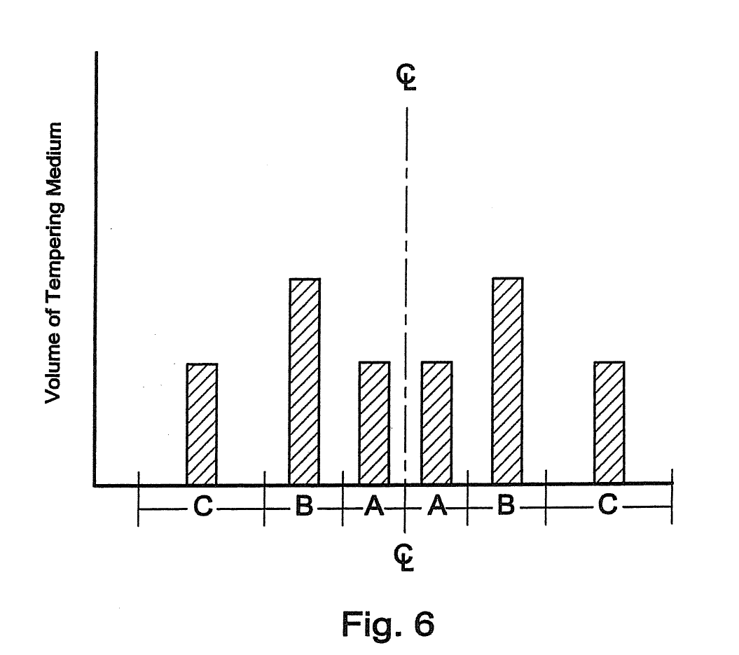

Notably, however, in the area designated by transverse distance “B”, the density of the second plurality of nozzles 18 can be expressed as y, where y is greater than x. Preferably, the nozzle density is, essentially, doubled, to on the order of 3,265 nozzles/m². The diameter of the nozzles is typically about 6-9 mm. Thus, the volume of tempering medium that can be delivered to a surface of the glass sheet is substantially increased, namely, on the order of 20% or more over the volume delivered by the conventional striper modules. A graphical representation of the variation in the volume of tempering medium delivered in the modified striper module is shown in FIG. 6. The temperature of the tempering medium is from 50° F. to 150° F.

In the area designated as transverse distance “C” the nozzle density once more is that of a conventional striper module, i.e. on the order of 816 nozzles/m². In accordance with the invention, in a direction transverse to either side of the centerline of the glass tempering assembly, transverse distances A, B, and C will be dependent on the size and geometry of the glass sheet 12 to be tempered.

As previously alluded to, the compressive stresses formed in the glass in the area of increased nozzle density is thought to be comprised of more numerous areas of stress, but of a lower magnitude than in conventional striper module configurations. The stress levels are on the order of at least 20% lower than observed in conventional striper modules.

### EXAMPLES

The benefits of the present invention can be seen by reference to the data presented in Table 1.

Fifteen vehicle windows (Column 1, 1-15) were tempered utilizing a conventional tempering apparatus which contained nozzles arranged in domino five and striper configurations, but with identical spacing between nozzles in all instances. The occurrence of splines ≧75 mm is summarized at the bottom of Table 1.

Examples (Column 2, 1-15) were tested utilizing a tempering apparatus according to the present invention, as shown in FIG. 4.

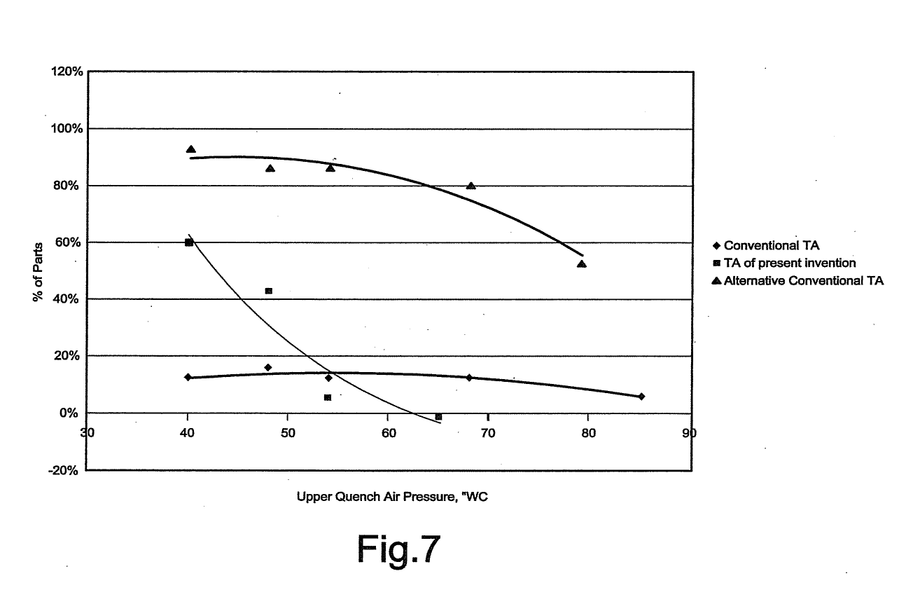

Examples (Column 3, 1-15) were tested utilizing an alternative conventional tempering apparatus as shown in FIG. 7. Once again, analysis of the data in Column 3 appears at the bottom of Table 1.

The air pressure introduced into the plenum beneath the different tampering apparatus modules was at two different levels, namely 54 inches of water column, and 65-68 inches of water column. As previously noted, the tempering apparatus modules of the present invention provides for a selective increase in the volume of tempering medium directed to the surface of the glass being tempered in those areas where the nozzle density is increased.

As can be seen in Table 1, the tempering in those areas of the glass where splines typically occur is significantly improved over conventional tempering modules both in the occurrence of splines ≧75 mm and the smaller size of the splines which do still occur. A graphical presentation of the data of Table 1 is provided in FIG. 7 of this application.

TABLE 1

| | 54″ WC | | | 65-68″ WC | | |
|---|---|---|---|---|---|---|
| | | TA | Alternative | | | Alternative |
| | Conventional | according to | conventional | Conventional | TA according | conventional |
| Example | TA | invention | TA | TA | to invention | TA |
| 1 | 64 | 57 | 132 | 68 | 55 | 88 |
| 2 | 72 | 75 | 98 | 65 | 52 | 88 |
| 3 | 61 | 58 | 95 | 60 | 46 | 100 |
| 4 | 66 | 61 | 121 | 86 | 58 | 86 |
| 5 | 59 | 54 | 106 | 61 | 52 | 52 |
| 6 | 66 | 58 | 64 | 88 | 47 | 79 |
| 7 | 68 | 51 | 112 | 72 | 55 | 131 |
| 8 | 88 | 51 | 70 | 52 | 52 | 88 |
| 9 | 54 | 57 | 110 | 57 | 45 | 96 |
| 10 | 54 | 58 | 103 | 49 | 46 | 70 |
| 11 | 62 | 54 | 132 | 62 | 68 | 83 |
| 12 | 48 | 52 | 98 | 60 | 54 | 82 |
| 13 | 83 | 47 | 100 | 70 | 58 | 69 |
| 14 | 62 | 55 | 97 | 51 | 70 | 100 |
| 15 | 70 | 68 | 87 | 64 | 55 | 87 |

Analysis of Splines Occurring

| | | | | | | |
|---|---|---|---|---|---|---|
| # ≧75 mm | 2 | 1 | 13 | 2 | 0 | 12 |
| % ≧75 mm | 13% | 7% | 87% | 13% | 0% | 80% |

TA = Tempering Apparatus

In a preferred configuration, a second tempering apparatus 22, substantially the same as the first tempering apparatus, but having a shape substantially conforming to the shape of the glass sheet to be tempered, and complementary to the first glass tempering apparatus is spaced opposite and apart from the first tempering apparatus 10 a distance sufficient for the glass sheet 12 to be tempered to pass therebetween, the second glass tempering apparatus 22 being capable of directing substantially the same volumes of tempering medium toward the second surface of the glass sheet.

Those skilled in the art will appreciate that changes and modifications to the invention are possible in light of the preceding description. It is, therefore, to be understood that within the scope of the appended claims the invention may be practiced otherwise than as specifically described.

What is claimed is:

1. A first glass tempering apparatus comprising, sequentially and in a direction parallel to the direction of travel of a shaped glass sheet to be tempered:
a first zone having a first plurality of nozzles to direct a tempering medium toward a first surface of the glass sheet, the nozzles being arranged in a series of staggered rows and configured to conform to the profile of the shaped glass sheet;
a second zone having a second plurality of nozzles to direct a tempering medium toward the surface of the glass sheet, the nozzles being arranged in substantially parallel rows, the spacing between the rows of nozzles varying in a direction transverse to the direction of glass travel, and forming a mirror image from the centerline of the at least second plurality of nozzles and configured to conform to the profile of the shaped glass sheet; and,
a third zone having a third plurality of nozzles to direct a tempering medium toward the surface of the glass sheet, the nozzles being arranged in a series of staggered rows substantially similar to the arrangement of the first plurality of nozzles.

2. The first glass tempering apparatus defined in claim 1, wherein a second glass tempering apparatus having a shape complementary to the first glass tempering apparatus and spaced opposite and apart therefrom, directs the tempering medium toward a second surface of the shaped glass sheet.

3. The first glass tempering apparatus defined in claim 1, wherein the arrangement of the nozzles in the second zone, transversely from the centerline is x nozzles per unit area for distance A, y nozzles per unit area for a distance B, and x nozzles per unit area for a distance C, where y is greater than x.

4. The second glass tempering apparatus defined in claim 2, wherein the arrangement of the nozzles transversely from the centerline, in the second zone, is x nozzles per unit area for distance A, y nozzles per unit area for distance B and x nozzles per unit area for distance C, where y is greater than x.

5. The first glass tempering apparatus defined in claim 1, wherein the shaped glass sheet is a vehicle glazing.

6. The first glass tempering apparatus defined in claim 1, wherein the tempering medium is air at a temperature of 50° F. to 150° F.

7. The first glass tempering apparatus defined in claim 1, wherein the volume of tempering medium directed at the first surface of the glass sheet by the at least second plurality of nozzles is at least 20% greater than the volume of tempering medium directed at the first surface of the glass sheet by the first and third pluralities of nozzles.

8. The first glass tempering apparatus defined in claim 1, wherein the diameter of each of the nozzles is between 6 and 9 mm.

9. The second glass tempering apparatus defined in claim 2, wherein the volume of tempering medium directed at the second surface of the glass sheet by the second plurality of nozzles is greater than or equal to the volume of tempering medium directed at the first surface of the glass sheet by the second plurality of nozzles of the first glass tempering apparatus.

10. A method of tempering glass sheets comprising:
providing one or more shaped glass sheets having first and second major surfaces serially conveyed by a glass transport system;
conveying the glass sheet between two glass tempering apparatus having complementary configurations and situated opposite and spaced apart a predetermined distance from each other; the two glass tempering apparatus each comprising multiple areas containing varying arrangements of pluralities of nozzles capable of directing a tempering medium toward each of the first and second major surfaces of the one or more shaped glass sheets,
wherein a plurality of nozzles in a first zone is arranged in multiple, staggered rows and configured to conform to the profile of the shaped glass sheets;
wherein a plurality of nozzles in at least a second zone is arranged in parallel rows and configured to conform to the profile of the shaped glass sheet, the nozzles being arranged so as to be capable of directing an increased volume of tempering fluid at certain designated portions of the first and second surfaces of the shaped glass sheets; and
wherein a plurality of nozzles in a third zone in multiple staggered rows in a manner substantially similar to the first area;
directing tempering medium from the pluralities of nozzles toward the first and second major surface of the glass sheet for a predetermined period of time; and
conveying the one or more shaped glass sheets from between the glass tempering apparatus.

11 A method of tempering glass sheets comprising:
providing a plurality of glass sheets, each having first and second major surfaces, and serially conveying the glass sheets via a glass transport system between two glass tempering apparatus having complementary configurations and situated opposite and spaced apart a predetermined distance from each other, the two glass tempering apparatus each comprising at least three zones in the direction of glass travel,
wherein, in the first zone, the glass sheets are subject to a substantially consistent volume of tempering medium contacting each major surface of the glass street both in the direction of travel through the zone, and transversely across the first zone;
wherein in the second zone, the glass sheets are subjected to an increased volume of tempering medium in first and second areas of the second zone a predetermined distance transverse from the center line of the tempering apparatus; and
wherein in the third zone, the glass sheets are subject to a substantially consistent volume of tempering medium contacting each major surface of the glass sheet, both in the direction of travel through the zone, and transversely across the third zone.
